(19) United States
(12) Patent Application Publication
(10) Pub. No.: US 2009/0279601 A1
(43) Pub. Date: Nov. 12, 2009

(54) Method and Apparatus of Displaying Video

(75) Inventors: Jacob Strom, Stockholm (SE); Tomas Akenine-Moller, Lund (SE)

Correspondence Address: COATS & BENNETT, PLLC, 1400 Crescent Green, Suite 300, Cary, NC, 27518, US

(73) Assignee: Telefonaktiebolaget LM Ericsson (publ), Stockholm (SE)

(21) Appl. No.: 12/117,309

(22) Filed: May 8, 2008

(51) Int. Cl. H04N 7/26

(52) U.S. Cl. 375/240.01; 375/E07.2

(57) ABSTRACT

A mobile device is configured to encode and decode a video sequence for rendering on a display. A user may choose a resolution level for the encoding/decoding process such that a device controller selectively encodes or decodes a subset of frames in the video sequence. Battery power may be saved by controlling the resolution level for the encoding/decoding process.

### TECHNICAL FIELD

The present invention relates generally to communication devices, and particularly, to methods of displaying video on communication devices.

### BACKGROUND

Mobile communication devices have become more portable over the years. Because they are mobile, consumers can use them to perform a variety of functions in almost any location. Historically, users have employed mobile communication devices to place and receive voice calls and access the Internet. However, the ability to deliver data at high speeds and at low cost is now beginning to drive the demand for mobile video and television services.

Mobile communication devices typically use rechargeable batteries as a power source. Although such batteries facilitate mobility, they can also be problematic. Particularly, most mobile devices execute a variety of advanced applications, such as compression/decompression software (i.e., video codec software), to render the three-dimensional (3-D) graphics associated with video and television services. Video codecs can be computationally expensive, and thus, represent a large portion of the battery's energy consumption.

Most state-of-the-art video codecs operate according to the H.263 and H.264 standards. As is known in the art, the H.263 and H.264 standards are respectively defined in the International Telecommunication Union (ITU-T) standards documents entitled, “Video coding for low bit rate communication” dated January 2005, and “H.264: Advanced Video Coding for Generic Audiovisual Services,” which was approved for publishing in November, 2007. Both of these documents are expressly incorporated herein by reference in their entirety.

Conventional video encoding/decoding techniques that operate according to these standards use a “low-complexity” profile targeted towards saving computational complexity. Low-complexity profiles use fewer computations and memory accesses during encoding/decoding operations, and thus, use less power. Such techniques indirectly make mobile devices more energy-efficient. However, these techniques offer no support for directly reducing energy consumption in a mobile device. Moreover, conventional techniques do not allow a user of a mobile communication device to reduce energy consumption by selecting between a plurality of methods to update a display during video playback.

### SUMMARY

The present invention reduces energy consumption in mobile devices having a rechargeable battery by allowing a user of the device to control a resolution at which a desired video sequence is rendered on a display. More particularly, the user may control the encoding/decoding process of the video sequence to use more or less energy as circumstances permit.

In one embodiment, the user of the mobile device, which comprises a controller and a memory, controls the encoding of an original video sequence. During encoding, the controller assigns an identifier, such as a number, to each pixel in each frame of the original video sequence. The controller then generates a plurality of sub-frames for each frame in the original video sequence, and decomposes the original video sequence by copying the pixels from the original frames to corresponding sub-frames. Particularly, the controller copies the pixels from the frames and inserts them into corresponding sub-frames such that each sub-frame comprises only like-numbered pixels. The controller then encodes the sub-frames using any video encoding standard known in the art.

In one embodiment, the controller encodes all sub-frames to generate an encoded video sequence. However, in other embodiments, the user may select how many of the sub-frames are encoded by selecting a resolution at which the encoded video sequence is to be rendered. Selecting a higher resolution means that more of the sub-frames are encoded to generate the encoded video sequence, while selecting a lower resolution means that fewer of the sub-frames are encoded to generate the encoded video sequence. A higher resolution requires more computations, while the lower resolution requires fewer computations. Thus, higher resolutions produce a higher quality image, but consume more energy than the lower resolutions.

In another embodiment, the user selects the resolution at which the controller will render a video sequence to the user. Based on this selected resolution, the controller selects and decodes one or more of the sub-frames to render the video sequence.

As with encoding, selecting a lower resolution means that the controller will perform fewer computations during the decoding process. This decreases the image quality, but also requires less energy. Thus, the length of time the battery can operate without needing a re-charge increases. Selecting a higher resolution means that the controller will perform more computations during the decoding process. This increases the image quality, but also consumes more energy. Thus, the length of time the battery can operate without needing a re-charge decreases.

### BRIEF DESCRIPTION OF THE DRAWINGS

FIG. 1 is a block diagram illustrating some of the component parts of a mobile communication device configured to operate according to one embodiment of the present invention.

FIG. 2 is a perspective view of a mobile device configured to operate according to one embodiment of the present invention.

FIG. 3 illustrates a screen update technique according to one embodiment of the present invention.

FIGS. 4-6 illustrate screen update techniques according to other embodiments of the present invention.

FIG. 7 illustrates a video sequence encoding technique according to one embodiment of the present invention.

FIG. 8 is a flow chart illustrating a method of encoding a video sequence according to one embodiment of the present invention.

FIG. 9 is a flow chart illustrating a method of decoding a video sequence according to one embodiment of the present invention.

### DETAILED DESCRIPTION

The present invention is directed to a method of reducing energy consumption in mobile devices capable of rendering a video stream to a user. More particularly, the present invention encodes and decodes a video sequence based on a user-selected resolution for the video sequence. Such control directly affects both energy consumption and the quality of the image being rendered. Specifically, selecting a lower resolution requires fewer computations and memory accesses during the encoding/decoding process. This consumes less battery energy but decreases image quality. Conversely, selecting a higher resolution requires more computations and memory accesses during the encoding/decoding process. While this increases image quality, it also consumes more battery power.

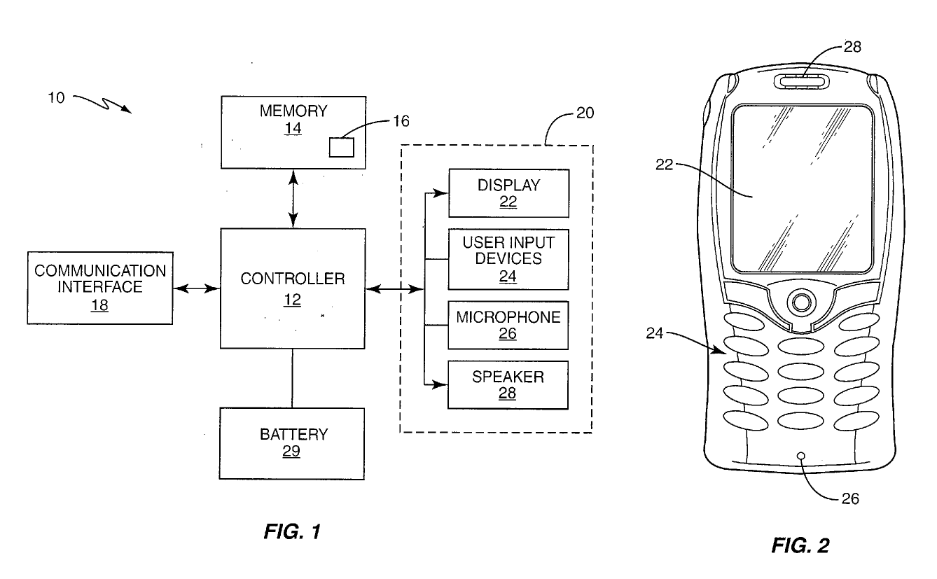

FIGS. 1 and 2 illustrate an exemplary mobile device 10 suitable for implementing the selective video compression/decompression according to one embodiment of the present invention. As used herein, the term “mobile device” connotes a broad array of device types. For example, the mobile device 10 illustrated in the figures comprises a cellular telephone; however, this is for illustrative purposes only. The mobile device 10 may comprise a Portable Digital Assistant (PDA), a palmtop or laptop computer, a satellite phone, or other type of portable device capable of rendering video to a user and powered by a rechargeable battery.

Mobile device 10 typically comprises, in its most basic configuration, a controller 12, memory 14, a communication interface 18, a user interface 20, and a rechargeable battery 29 to power the mobile device 10. The controller 12 may comprise one or more microcontrollers, microprocessors, hardware circuits, or any combination thereof. Memory 14 may comprise volatile memory such as random access memory, non-volatile memory such as read-only memory, FLASH memory, or some combination thereof. Memory 14 typically stores application and data to control the operation of controller 12. As described later in more detail, one such application program comprises a video compression/decompression application 16 that affects power consumption in the mobile device 10 by allowing the user to selectively increase and decrease the number of computations and memory accesses required for encoding/decoding video at the mobile device 10.

The communication interface 18 provides one or more communication interfaces for communicating control signaling and voice and/or data traffic over one or more communication networks (not shown). Some examples of the types of networks suitable for use with mobile device 10 include, but are not limited to, cellular networks, wireless local area networks, short-range wireless networks, and conventional wireline networks. User interface 20 comprises a collection of devices that enable the user to interact with the mobile device 10. The most basic components of the user interface 20 include a display 22, one or more user input devices 24 such as a keypad, a microphone 26, and a speaker 28. The display 22 may comprises a touch screen display that also functions as a user input device 24. In one embodiment, the user input devices 24 allow the user to selectively increase and decrease the number of computations and memory accesses as hereinafter described.

The mobile device 10 may also have additional components not specifically illustrated in FIGS. 1 and 2. For example, the mobile device 10 may include mass storage devices or other hardware to enable users to store data in a variety of storage media. Examples of such mass storage devices may include magnetic or optical disk drives, or suitable interfaces, such as USB, FIREWIRE, for example, for connecting to external storage devices.

As previously stated, mobile devices, such as mobile device 10 of the figures, employ rechargeable batteries. These types of batteries can provide power to the mobile device 10 only for a limited time before needing a recharge. The amount of time that the battery can provide power depends in part on the types of applications that the mobile device 10 executes. For example, conventional compression/decompression applications (i.e., video codecs) executed by mobile device 10 for video functions may, at times, consume more battery power than do non-video related applications. Therefore, the batteries in mobile devices that use a conventional video codec may not last as long and could need more frequent recharges.

The present invention addresses this problem by allowing a user of the device to vary the resolution with which the mobile device 10 will render the video sequence. More particularly, the present invention provides a mechanism that allows a user to vary the quality of a rendered video in light of a desired power savings by permitting the user to selectively increase and decrease a resolution for a video sequence. Selecting a lower resolution requires fewer computations and memory accesses during the encoding/decoding process. This consumes less battery energy but decreases image quality. Selecting a higher resolution requires more computations and memory accesses during the encoding/decoding process. While this increases image quality, it also consumes more battery power. Thus, the present invention permits the user to control the life of the rechargeable battery 29 indirectly by allowing the user to control the quality of the screen updates.

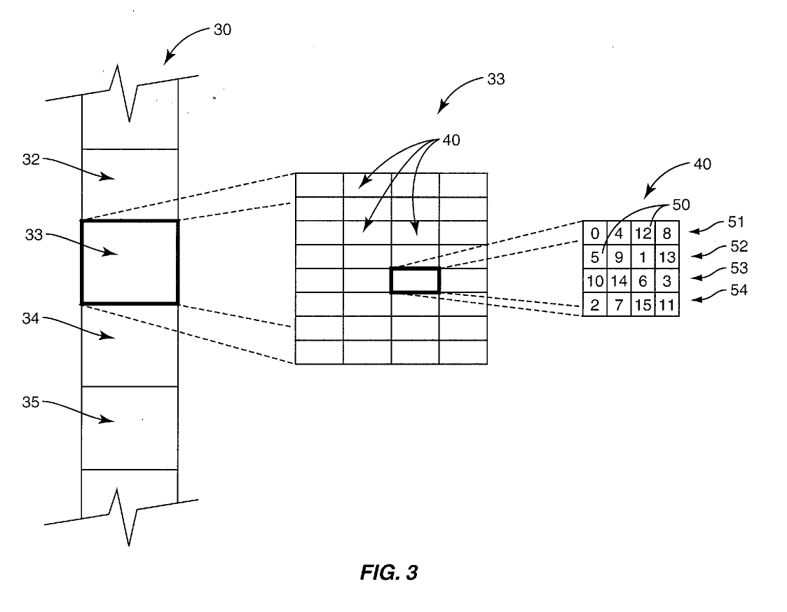

FIG. 3 illustrates how video information may be arranged for rendering to the user in one embodiment of the present invention. As seen in FIG. 3, a video sequence 30 comprises a plurality of video frames 32-35. Each frame comprises a plurality of video “tiles” 40, and each tile 40 further comprises a plurality of pixels 50, each of which is assigned an identifier value between 0 and 15. The assigned identifier values are not related to the true color value of a given pixel. Rather, as described in more detail later, the identifier values are used to identify which of a plurality of sub-frames the pixel belongs.

Assigning the identifier values may be accomplished using any means known in the art; however, in one embodiment, the controller 12 assigns values using a Linear Congruential Generator (LCG) function when generating the frames. LCG functions generate pseudo-random numbers and are well-known in the art. Thus, the details of how an LCG function operates are not described in detail here. It is sufficient to say that the rendering device knows the function that was used to assign the identifier values so that upon rendering the video, the controller 12 can perform the reverse function and place the selected pixels in their proper positions. In some embodiments, such assignment information may be stored and accessed by controller 12 when rendering the frames. If a remote device will render the frames, the assignment information may be sent to the remote device when establishing a communication channel, or with the video frames.

Here, the figure illustrates the sequence as having four frames 32-35. However, this is for illustrative purposes only. Those skilled in the art will readily appreciate that most video sequences commonly have more than four frames. Similarly, the number of tiles 40 per frame may vary as could the number and arrangement of pixels 50. In this embodiment, the pixels 50 are arranged in a 4×4 matrix; however, the number and configuration of the pixels 50 is not germane to the present invention.

With the present invention, the controller 12 decompresses only a subset of the pixels for a given video frame and then renders those updated pixels. Which subset is decompressed may be controlled by the user. For example, the pixels 50 in tile 40 of FIG. 3 are arranged in four pixel rows 51-54. Each pixel 50 has a different identifier value numbered 0-15. Based on user input, the controller 12 may only decompress the pixels 50 that have been assigned an odd-numbered identifier value each time it processes an odd-numbered video frame, and leave the pixels 50 having the even-numbered identifier values unchanged. Those pixels 50 that remain unchanged could retain their pixel colors from a previous frame.

In this example, controller 12 would decompress none of the pixels 50 in pixel row 51 because they have even-numbered identifier values (i.e. 0, 4, 12, and 8). In the second pixel row 52, however, all the pixels 50 would be decompressed since they each have odd-numbered identifier values (i.e., 5, 9, 1, and 13). In the third pixel row 53, only one pixel 50 would be decompressed (i.e., 3) and in the fourth pixel row, two pixels would be decompressed (i.e., 7 and 11). Thus, after decompression of the pixels 50 having odd-numbered identifier values, a user will view an image where only half of the pixels 50 have been updated.

Similarly, each time controller 12 processes an even-numbered video frame 32, 34, controller 12 will only decompress the pixels 50 having even-numbered pixel identifier values. The pixels 50 having the odd-numbered pixel identifier values will remain unchanged, and thus, the user will view an image where only the other half of the pixels 50 have been updated. Pixel rows that are not updated will retain the pixel colors from the previous frame.

Decompressing a subset of the pixels 50 negates the need for decompressing every pixel 50 for every video frame. Therefore, the present invention requires fewer computations than do conventional video codec applications. However, because the present invention is responsive to the user's input, the user can select to decompress more or fewer pixels 50 as needed or desired. The trade-off, of course, is in power source savings for image quality.

For example, in situations where a user might prefer high-quality images, the user might choose to decompress most or all of the pixels 50 for selected video frames. This selection would require more computations, and thus, consume more energy. In situations where user might need only images of lower quality, the user might select to decompress only a few of the pixels 50 during selected video frames. This selection would consume less power from the battery 29 because it requires fewer computations, but it also lengthens the effective battery life.

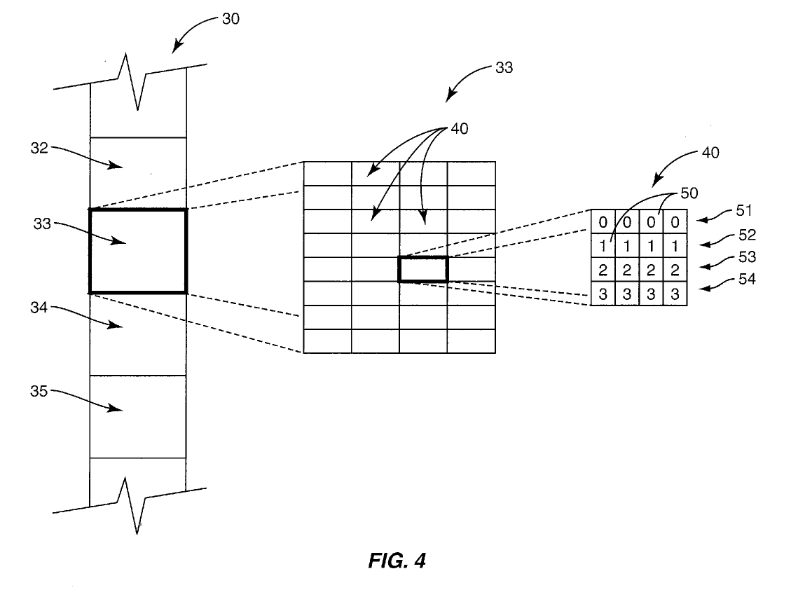

FIG. 4 illustrates an embodiment wherein the user selects an update pattern that decompresses only a single pixel row per tile every video frame. Each pixel in the pixel rows 51-54 is assigned one of four different pixel numbers 0-3. In general, the controller will decompress a given pixel for updating when the following calculation (1) results in its pixel number (in this example, 0-3):

framenumber mod n (1)

wherein “framenumber” is a counter that gets incremented each time the controller 12 processes a video frame, and wherein “n” is the number of different pixel numbers in the tile. In the embodiment of FIG. 4, n equals 4.

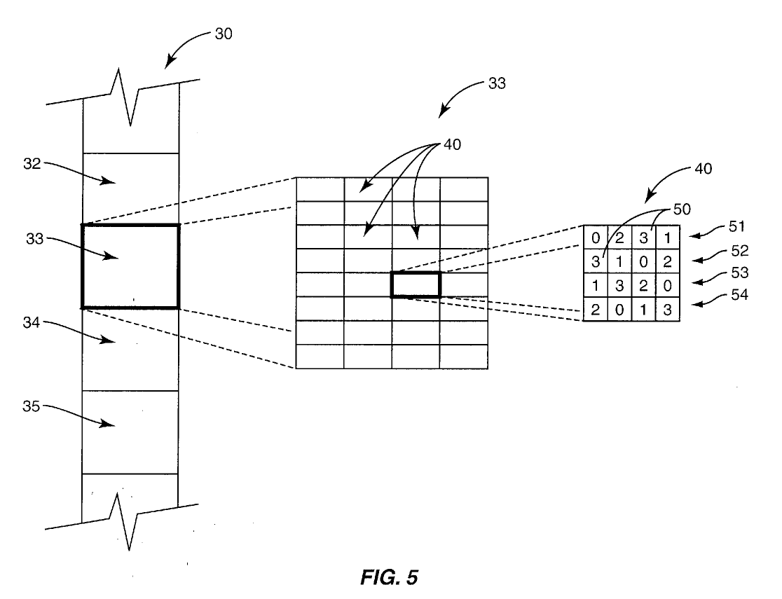

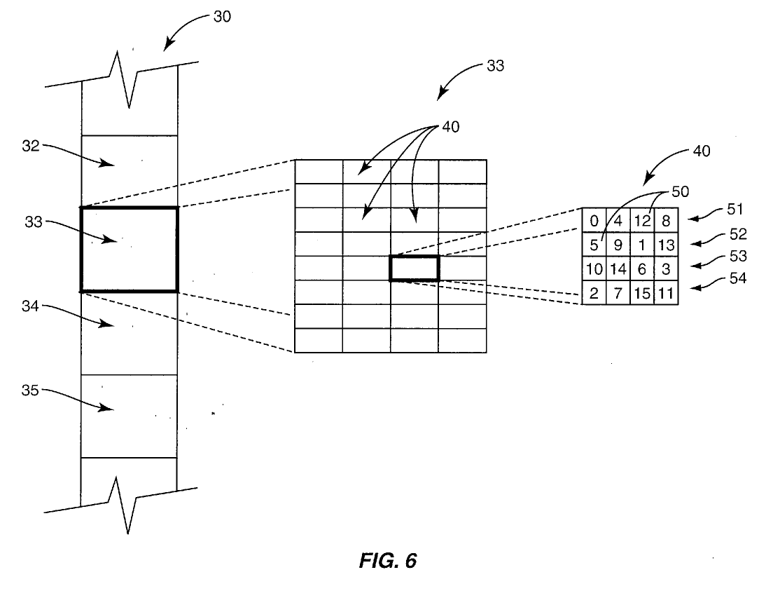

Thus, for video frame 32, the controller 12 determines that 32 mod 4 equals 0. The controller 12 will therefore decompress only pixel row 51 because it contains ‘0s.’ Likewise, for video frame 33, the controller 12 determines that 33 mod 4 equals 1. The controller 12 will then decompress only pixel row 52 because it contains ‘1s.’ Similarly, controller 12 will employ similar calculations to decompress and decode pixel rows 53 and 54 for video frames 34 and 35, respectively. Thus, with each successive video frame 32-35 that is rendered on display 22, only a single pixel row 51-54 will change while the remaining pixel rows retain the properties from the previous video frame. Patterns that result in an update to a single pixel row or to alternating pixel rows every video frame might produce undesirable artifacts that are visible to the user. Therefore, in another embodiment, the present invention pseudo-randomly assigns identifiers such as numbers to the pixels in the tile. For example, as seen in FIG. 5, tile 40 comprises a 4×4 matrix of pixels 50. Like the embodiment of FIG. 4, each pixel 50 is assigned a pixel identifier value 0-3. Unlike the previous embodiment, however, the pixel identifier values 0-3 are pseudo-randomly or randomly distributed across the tile 40. Thus, controller 12 may employ calculation (1) to determine which pixels 50 get updated, but the resultant pixel updates are spread across the tile 40. In this example, one pixel 50 per column and row in tile 40 is updated. In other words, for frame 32, controller 32 might decompress and decode only those pixels 50 having a pixel identifier value of ‘0’ in each tile 40. Similarly, controller 12 will perform a similar function for pixel identifier values ‘1,’ ‘2,’ and ‘3’ in each tile 40 in video frames 33, 34, and 35, respectively. This random displacement breaks up the simpler “scan line” patterns of the previous embodiments and disguises the visible artifacts created by those simpler updates.

FIG. 6 illustrates another embodiment that avoids undesirable scan line patterns. The pixels 50 in the magnified tile 40 are arranged in a 4×4 matrix and have a unique identifier value 0-15. The pixels 50 in adjacent tiles 40 could also have identifier values from the same range (i.e., 0-15), but might have different distributions.

In this embodiment, the pixels 50 that get updated can vary with a user-selected quality level. Because there are 16 different identifiers in this example, there can be 16 different quality levels. A quality level of ‘11,’ for example, might cause the controller 12 to decompress eleven pixels 50 in each tile 40 of each frame 32-35. Thus, for frame 32, the controller 12 could update those pixels 50 having an identifier value between 0 and 10. Similarly, for frame 33, the controller 12 could decompress the pixels 50 having an identifier value of between 0-5 and 11-15. For frame 34, the controller 12 could update the pixels 50 having an identifier value of 0 and 6-15. Lower quality levels might cause fewer pixels 50 to be updated, while higher quality levels might cause more pixels 50 to be updated. Other patterns are also possible.

It should be noted that with the present invention, the displayed video converges to an accurate representation of a subject image when nothing in the video moves. Therefore, by allowing a user to control decompression and decoding, the present invention can provide high image quality and use less power. As described later in more detail, the present invention can vary the number if pixels 50 that get decompressed and decoded according to a level of detected movement. This can increase the effective life of the battery between re-charges. In contrast, conventional update methods might continue to perform decompression and decoding operations on the pixels in the same manner as that performed for fast-moving images even if nothing is moving. These conventional techniques might therefore draw substantially the same amount of power for both cases thereby decreasing the effective battery life between re-charges.

Additionally, low-pass filtering and/or down sampling of the data in a video sequence might provide data reduction. Such techniques might also require fewer computations for decompression and decoding and save power resources. However, the images in the video sequences processed by these techniques will not converge as they do in the present invention. Rather, the reduced amount of data results in a blurry image. Further, these techniques do not allow a user to select a decompression rate that affects image quality, as does the present invention.

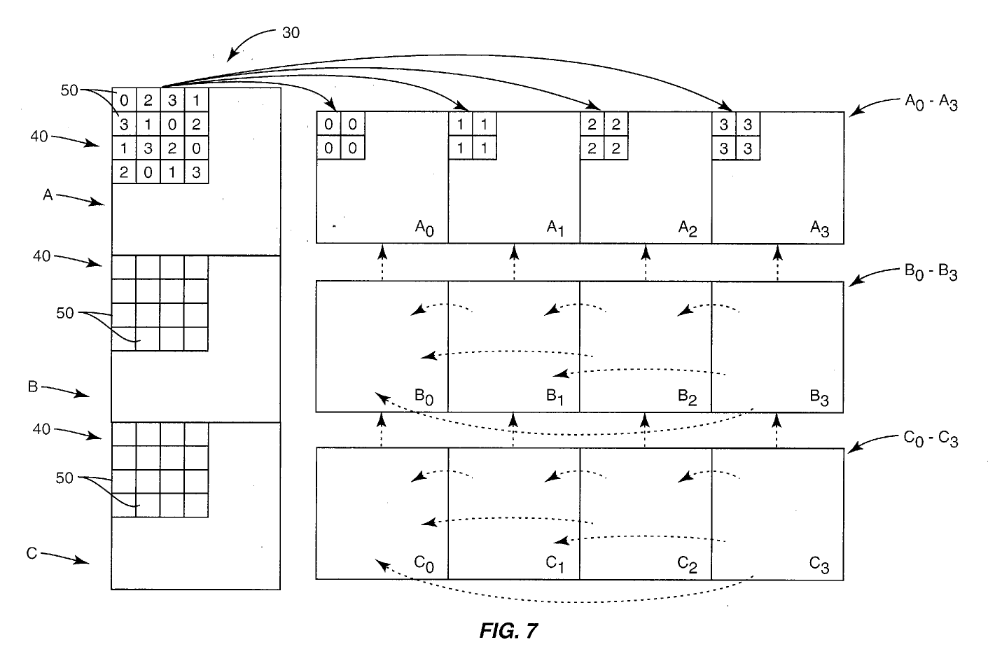

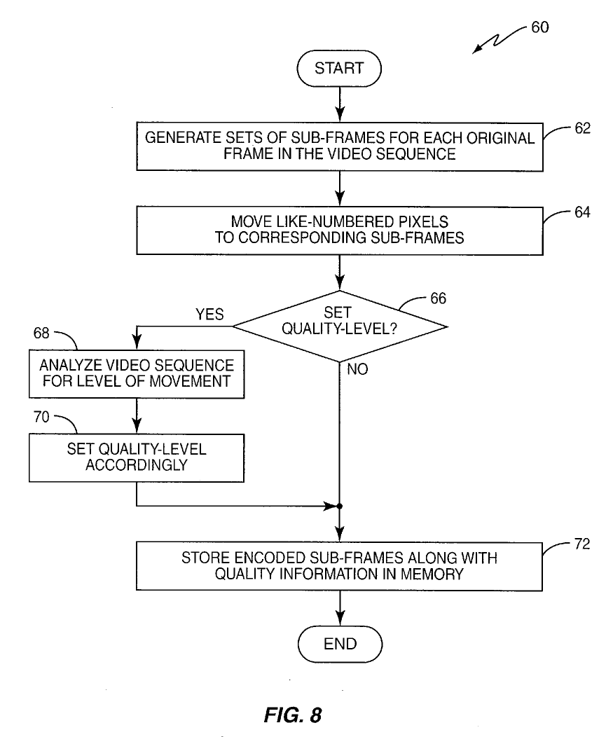

FIG. 7 illustrates how the present invention encodes a video sequence according to one embodiment. In FIG. 7, an original video sequence 30 comprises 3 frames A, B, and C. Each frame A-C comprises a plurality of tiles 40 having a plurality of pixels 50. Each pixel 50 has an assigned pixel identifier value 0-3, which, as stated previously, may be assigned based on a selected function. As above, the pixel identifier values are pseudo-randomly distributed throughout the tile 40.

To encode the video sequence 30, the present invention generates a plurality of sub-frames for each of the original video frames A-C. Each of the sub-frames represents a part of an image in the video sequence. Thus, multiple sub-frames together represent an image. As seen in FIG. 7, the sub-frames are labeled A0-A3 for frame A, B0-B3 for frame B, and C0-C3 for frame C. Together, A0-A3 represent one image, while B0-B3 and C0-C3 represent different images, respectively. During encoding, the present invention moves each of the pixels 50 to one of the sub-frames. Here, the controller 12 moves the pixels 50 that are numbered ‘0,’ ‘1,’ ‘2,’ and ‘3’ from the original frame A to corresponding sub-frames A0, A1, A2, and A3. Similarly, the controller 12 moves pixels from the original frames B and C to their corresponding sub-frames B0-B3 and C0-C3. The result is a new video sequence A0, A1, A2, A3, B0, B1, B2, B3, C0, C1, C2, and C3 generated from the original video sequence 30. Using a compression standard, such as H.264, for example, the controller 12 then compresses the sub-frames A0-C3 instead of the original video sequence A-C.

During the rendering of the sub-frames A0-C3, the user can select a desired image quality level. Then, only those pixels associated with that level are decompressed for display. For example, if the user selects a quality level of ‘0’, the controller 12 will decompress only the pixels 50 having an identifier value of ‘0’ contained in the tiles 40 of sub-frames A0, B0, and C0. The pixels 50 will likely have different positions in the tiles 40 and the sub-frames A0, B0, and C0. The controller 12 performs the reverse function to determine the positions in the frame for these pixels 50. The images A, B, and C are then reconstructed as previously described using only those pixels 50. Similarly, if the user selects a quality level of ‘3,’ the controller 12 will decompress all pixels 50 having an identifier value of 0-3 in each of the sub-frames A0-C3, and render them in their proper positions in the frame to the user. Thus, in this example, each sub-frame A0-A3, B0-B3, and C0-C3 would be combined to render complete images A, B, and C, respectively. The user is also able to select quality levels of ‘1’ or ‘2’ to effect decompression of those corresponding pixels 50 in their corresponding sub-frames A0-C3.

As above, the controller 12 will not decompress non-selected pixels in the sub-frames. Therefore, to complete the image, these pixels retain the pixel colors of a previous sub-frame. To accomplish this, the present invention predicts which of the previous sub-frames to use to determine the pixel colors for the non-selected pixels.

There are a variety of methods that the controller 12 might perform to effect such a prediction process. The most common technique would be for the controller 12 to use an immediately previous sub-frame. However, with pseudo-random sequences such as those of the present invention, such techniques are not always possible. Therefore, the present invention contemplates another prediction process based on a user-selected quality level.

In one embodiment, for a selected quality level of ‘2,’ the controller 12 might use the pixel colors contained in sub-frame A2 when decompressing sub-frame B0. Similarly, where the user selects a quality level of ‘1,’ controller 12 might use the pixel colors contained in sub-frame A1 when decompressing sub-frame B1. Thus, the controller 12 can only use those sub-frames that are certain to have been decompressed as prediction sub-frames. If the quality level were ‘0,’ ‘1,’ or ‘2,’ for example, the controller 12 would not be able to use sub-frames A3, B3, and C3 as prediction sub-frames. Particularly, with a quality level of 0-2, none of sub-frames A3, B3, and C3 would have been previously decompressed, and thus, none would be available for use by the controller 12 in its prediction process.

As seen in FIG. 7, for example, sub-frame B0 must use sub-frame A0 to predict the non-selected pixel colors since sub-frame A0 must have been decompressed to render the video. Likewise, sub-frame B2 can predict non-selected pixel colors from sub-frames A2, B0, or B1 since it would be certain that those sub-frames would have been decompressed. Exactly which sub-frame A2, B0, or B1 would be selected in that case depends on the user-selected quality level. The dotted arrows in FIG. 7 illustrate the allowed predictions for a given sub-frame A0-C3.

In one embodiment, the present invention can automatically set the quality level during the encoding process by analyzing the amount of movement in a given set of video frames. This information can then be provided with the new video sequence so that the controller 12 can alter the quality level during playback. Thus, in a scene with little movement, the controller 12 may set the quality level at ‘0’ during the encoding process. As movement increases, the controller may set the quality level to a higher level. During playback, the controller 12 will alter the user-selected quality-level as indicated by these controller-provided settings.

It should be noted here that the present invention may be configured to alternatively set the quality level automatically during the decoding process. In these cases, the controller 12 might only decompress and decode the pixels 50 in those sub-frames that correspond to the determined quality level. In another embodiment, the controller 12 might always decompress and decode all pixels 50 in all sub-frames, but only send those pixels 50 that correspond to the determined quality level to the display. Those pixels that do not correspond to the determined quality level would not be sent to the display, although they may be used as prediction frames for predicting pixel colors.

FIG. 8 shows a method 60 by which one embodiment of the present invention encodes a video sequence. Method 60 begins when the controller 12 generates the plurality of sub-frames for each original video frame in the target video sequence (box 62). The controller 12 then analyzes each frame and moves the pixels having like pixel identifier values (e.g., 0, 1, 2, 3, . . . ) to their corresponding sub-frames (box 64). If the controller 12 is to set the quality level for decoding (box 66), the controller 12 will analyze the video sequence to determine the amount of movement (box 68) and set the quality level accordingly (box 70). Once complete, the controller 12 will store the new video frames in memory. If the controller 12 determined quality level settings, that information is saved in memory as well.

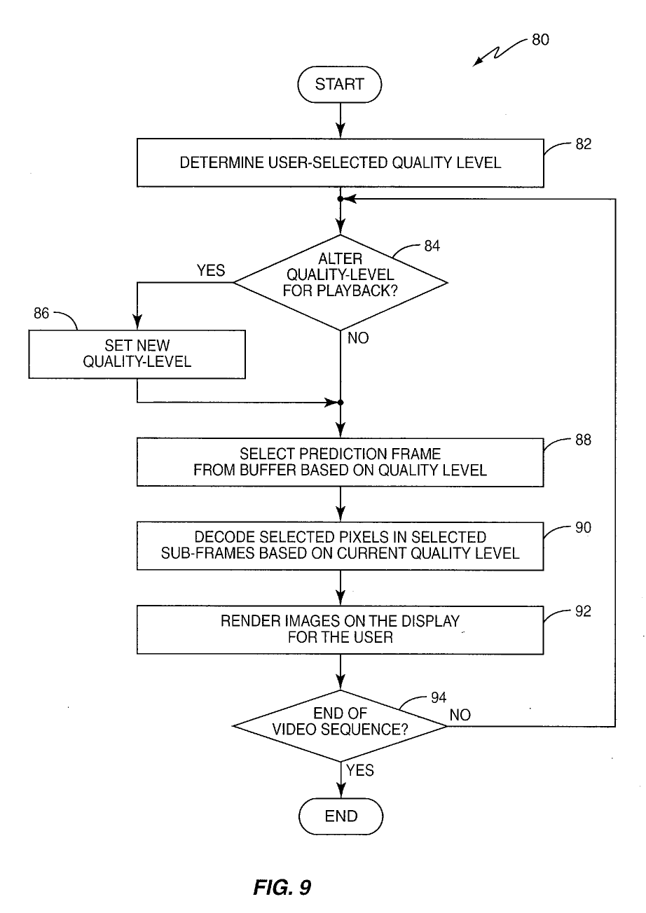

FIG. 9 shows a method 80 by which one embodiment of the present invention decompresses the encoded video sequence for rendering on display 22. Method 80 begins when controller 12 determines the user-selected quality level (box 82). For example, the user may input the desired quality level via the user input device 24. The controller 12 then reads the video sequence from memory 14 and determines whether to alter the quality level (box 84). Whether to alter the current quality level depends on whether the controller 12 analyzed the video sequence for movement during the encoding process and saved that information to memory 14 (see e.g., FIG. 8). If so, the controller 12 will set the current quality level to the quality level provided during the encoding process (box 86).

Controller 12 then selects a “prediction” frame to use for the non-selected pixel numbers based on the current quality level (box 88). For example, if the current quality level is ‘1’, the controller will decompress only those pixels assigned an identifier value of ‘0’ or a ‘1.’ However, controller 12 will not decompress those pixels assigned an identifier value of ‘2’ or a ‘3.’ Therefore, the controller 12 copies the pixel colors of these non-selected pixels from the selected prediction frame. For the initial video frame, the controller 12 may simply decompress all pixels regardless of the selected quality level. The controller 12 then decompresses the selected pixels in selected sub-frames based on the current quality level (box 90) and renders the final image to the user on display 22 (box 92). This procedure may continue until the end of the video sequence (box 94).

The previous embodiments illustrate the present invention as varying the quality level for decompression at playback. However, the present invention is not so limited. In another embodiment, the user may set the quality level for the encoding process. The controller 12 would then only encode and store the pixels corresponding to the selected quality level. Thereafter, on playback, the sub-frames would simply be rendered as they were stored. This embodiment may additionally save memory resources; however, it removes the ability to alter the quality level at playback.

In some cases, the user may wish to have the ability to alter the quality level during playback. For these embodiments, the present invention will need to alter its prediction frames for predicting pixel colors. For example, for a current quality level of ‘1,’ the controller 12 can use sub-frame A1 when decoding sub-frame B1. After the user increases the quality level to ‘2,’ for example, the controller 12 would decompress and decode a sub-frame B2. However, the pixel colors for the non-selected pixels of sub-frame B2 are predicted from sub-frame A2, which was not decoded prior to the quality level increase. Therefore, those pixels 50 would not be available for the prediction process.

The present invention can address this problem in a variety of ways. In one embodiment, the present invention could be configured to allow quality level increases to take effect only at Intra-Coded Frames (I-frames) in the video. I-frames do not use previously decoded frames for prediction. Therefore, none need be available for the I-frame. The quality level increase would take effect at the I-frame, and the subsequent frames would use previously decoded sub-frames for prediction as previously described.

In another embodiment, the controller 12 could always decode one more sub-frame than is needed according to the current quality level. For example, if the current quality level is ‘1,’ the controller 12 would decode sub-frames A0, A1, B0, B1, C0, and C1, as previously described. In addition, controller 12 would decode A2, B2, and C2. The controller 12 would then have immediate access to a previously decoded sub-frame (e.g., sub-frame A2 when decoding B2), and could continue to decode the sub-frames according to the increased quality level. For current quality level increases from ‘2’ to ‘3,’ the controller 12 could be configured to allow prediction from other sub-frames. For example, controller 12 could be configured to allow prediction between sub-frame B3 and sub-frames A0-A2 instead of A3, as previously stated.

The present invention may, of course, be carried out in other ways than those specifically set forth herein without departing from essential characteristics of the invention. For example, the previous embodiments show tile 40 as comprising a 4×4 matrix. However, the tiles 40 may be any size matrix as needed or desired. In some embodiments, tile 40 can comprise a 2×2 matrix, and further, may be assigned any pixel identifier value in any desired range. Thus, the present invention is not limited to identifier values of 0-3 or 0-15 as shown herein. Nor is the present invention limited to the distribution techniques shown herein. The present invention may, for example, employ a lookup table that contains information on positioning the pixels in tile 40.

Additionally, the controller 12 is configurable to decompress and decode multiple pixels per frame at a time. For example, the controller 12 might decompress and decode pixels having an identifier value of ‘0’ and ‘3’ for each frame. Further, the description specifically mentions H.264 as being a codec used by the present invention. However, those skilled in the art will appreciate that this is for illustrative purposes only. The present invention may employ other codecs not specifically mentioned herein as needed or desired.

The present embodiments, therefore, are to be considered in all respects as illustrative and not restrictive, and all changes coming within the meaning and equivalency range of the appended claims are intended to be embraced therein.

What is claimed is:

1. A method of encoding a video sequence having a plurality of frames, the method comprising:
assigning a value to selected pixels in the frames of a first video sequence;
decomposing the pixels to generate a plurality of sub-frames, each sub-frame comprising one or more like-valued pixels; and
encoding selected sub-frames to generate an encoded video sequence.

2. The method of claim 1 further comprising determining a resolution level for the sub-frames.

3. The method of claim 2 wherein decomposing the pixels comprises copying the like-valued pixels from the frames of the first video sequence to corresponding sub-frames based on the resolution level.

4. The method of claim 3 wherein copying the like-valued pixels to the sub-frames comprises copying the like-valued pixels that correspond to the resolution level to the corresponding sub-frames.

5. The method of claim 2 further comprising determining the resolution level based on an analyzed level of movement in the first video sequence.

6. The method of claim 5 wherein encoding selected sub-frames comprises encoding the sub-frames based on the resolution level.

7. The method of claim 6 further comprising varying the resolution level according to the analyzed level of movement in the first video sequence.

8. The method of claim 6 further comprising storing the resolution level information and the encoded video sequence in memory.

9. A mobile device comprising:
a memory to store a first video sequence having a plurality of frames; and
a controller configured to:
assign a value to selected pixels in the frames of the first video sequence;
decompose the pixels to generate a plurality of sub-frames, each sub-frame comprising one or more like-valued pixels; and
encode selected sub-frames to generate an encoded video sequence.

10. The mobile device of claim 9 wherein the controller is configured to decompose the pixels by copying the like-valued pixels from the frames of the first video sequence to corresponding sub-frames based on a determined resolution level.

11. The mobile device of claim 10 wherein the controller is configured to copy the like-valued pixels that correspond to the resolution level to the corresponding sub-frames.

12. The mobile device of claim 10 wherein the controller is configured to analyze the first video sequence to determine a level of movement, and assign the resolution level based on the level of movement.

13. The mobile device of claim 12 wherein the controller is configured to encode the selected sub-frames based on the resolution level.

14. The mobile device of claim 12 wherein the controller is configured to vary the resolution level according to the level of movement in the first video sequence.

15. The mobile device of claim 12 wherein the controller is configured to store the resolution level information and the encoded video sequence in the memory.

16. A method of decoding a video sequence comprising:
determining a selected resolution level for rendering an encoded video sequence comprising a plurality of sub-frames;
decoding selected sub-frames based on the selected resolution level; and
generating a decoded video sequence for rendering on a display based on the decoded sub-frames.

17. The method of claim 16 wherein determining a selected resolution level comprises receiving the selected resolution level as user input.

18. The method of claim 16 wherein determining a selected resolution level comprises setting the resolution level based on information associated with the encoded video sequence.

19. The method of claim 18 further comprising varying the selected resolution based on the information associated with the encoded video sequence.

20. The method of claim 16 wherein each selected sub-frame comprises one or more like-valued pixels, and wherein decoding the selected sub-frames comprises decoding the like-valued pixels associated with each selected sub-frame to generate a first subset of pixels.

21. The method of claim 20 wherein generating the decoded video sequence comprises generating a plurality of frames to include the first subset of pixels.

22. The method of claim 21 further comprising selecting a previously rendered sub-frame based on the selected resolution level, and using the pixels in the previously rendered sub-frame to generate the decoded video sequence.

23. A mobile device comprising:
a memory configured to store an encoded video sequence having a plurality of sub-frames; and
a controller configured to:
determine a selected resolution level for rendering the encoded video sequence;
decode selected sub-frames based on the selected resolution level; and
generate a decoded video sequence for rendering on a display based on the decoded sub-frames and the previously rendered sub-frame.

24. The mobile device of claim 23 further comprising a user input device, and wherein the controller is configured to receive the selected resolution level as user input from the user input device.

25. The mobile device of claim 23 wherein the controller is configured to set the resolution level based on information associated with the encoded video sequence.

26. The mobile device of claim 25 wherein the controller is configured to vary the selected resolution level during playback of the decoded video sequence based on the information associated with the encoded video sequence.

27. The mobile device of claim 23 wherein each selected sub-frame comprises one or more like-valued pixels, and wherein the controller is configured to decode the one or more like-valued pixels to generate a first subset of pixels.

28. The mobile device of claim 27 wherein generating the decoded video sequence comprises generating a frame for the decoded video sequence to include the first subset of pixels.

29. The mobile device of claim 28 wherein the controller is further configured to select a previously rendered sub-frame based on the selected resolution level.

30. The mobile device of claim 29 wherein the previously rendered sub-frame comprises a second subset of like-valued pixels, and wherein the controller is configured to include the second subset of pixels in the generated frame.

31. The mobile device of claim 30 wherein the second subset of pixels corresponds to pixels included in non-selected frames.
